(19) United States
(12) Patent Application Publication
(10) Pub. No.: US 2016/0158632 A1
(43) Pub. Date: Jun. 9, 2016

(54) SNOW SKI AND SNOWBOARD BODY HAVING ELECTROLUMINESCENT EDGES AND/OR ELECTROLUMINESCENT SURFACE AREAS FOR ENHANCED SAFETY AND STYLE

(71) Applicant: William M. Bolt, Liberty, IN (US)

(72) Inventor: William M. Bolt, Liberty, IN (US)

(21) Appl. No.: 14/562,575

(22) Filed: Dec. 5, 2014

(51) Int. Cl. A63C 5/06; F21V 23/02; F21V 23/00; B60Q 1/26; F21V 33/00

(52) U.S. Cl. CPC A63C 5/06; B60Q 1/2615; F21V 33/008; F21V 23/003; F21V 23/02; F21Y 2105/006

(57) ABSTRACT

An illuminated ski having illuminated edges and/or illuminated extended surface areas. An onboard power source is connected to a light source placed within and along a channel formed along the periphery, and another light source that is substantially flat and placed on a substantial portion of the top surface and/or bottom surface of a ski. A substantially transparent protective layer can be placed over the substantially flat and spatially extended light source on the top and/or bottom surface. A controller can change the appearance of the light source during operation, such creating a simulated motion effect, and a communications ink can be remotely actuated by the controller.

### FIELD OF THE INVENTION

The present invention relates generally to skis, and more specifically to illuminated skis, such as illuminated snow skis and illuminated snowboards.

### BACKGROUND OF THE INVENTION

Skis have been used for centuries. Originally for use in a winter sport, early skis were constructed from flat, elongated pieces of wood, upon which a person stands near the center of the length of the ski and glides over snow assisted by gravity or the use of poles. While the rider normally attaches one ski to each foot through the use of a binding that secures the ski to a boot, snowboards are specialized skis that allow a user to place both feet on a single ski and ride them like a surfboard or skateboard. The use of skis has extended to non-snow applications, such as water, i.e., water skis.

The appearance of skis is very important to people involved in the sport of skiing. Skis often incorporate bright colors and graphics on the surfaces of the skis, which are useful for locating a lost ski in the snow, or for identifying a pair of skis stored among many other pairs. However, night skiing has grown in popularity, and the appearance of skis and snowboards is less noticeable at night, because the bright colors and graphics are less visible in -light conditions, such as ski slopes that are only illuminated by floodlights placed along the edges of the ski slopes.

### SUMMARY OF THE INVENTION

The present invention solves the problems described above by providing illuminated areas and illuminated edges to the surfaces and edges of skis. By incorporating an onboard battery and a controller, illuminated effects, such as surface lighted graphics that provide simulated motion effects on the top and/or bottom surfaces of the skis can be provided for both decorative and utilitarian aspects, such as enhanced safety.

A general aspect of the invention is an illuminated snow ski, including a snow ski body having disposed thereon a power source; first and second conductive leads connected to the power source; and a spatially extended electroluminescent light source connected to the first and second conductive leads.

In some embodiments, the spatially extended electroluminescent light source includes at least one electroluminescent wire extending along an edge of the ski body.

In some embodiments, the ski body includes a channel formed within the edges of the ski body and the spatially extended light source is disposed within the channel.

In some embodiments, the power source is embedded within the top surface of the ski body.

In some embodiments, the power source is embedded in a central area of the top surface of the ski body.

In some embodiments, the spatially extended light source includes a substantially flat electroluminescent material that is placed on at least one of the top surface and the bottom surface of the ski body.

In some embodiments, the spatially extended light source includes a substantially flat electroluminescent material that is shaped so as to form a pattern of illumination on at least one of the top surface and the bottom surface of the ski body.

In some embodiments, the spatially extended light source includes at least two substantially flat areas of electroluminescent material that are each shaped so as to form at least two respective patterns of illumination on at least one of the top surface and the bottom surface of the ski body.

In some embodiments, the at least two substantially flat areas of electroluminescent material are sequentially illuminated so as to create a motion effect.

In some embodiments, a controller is connected between the light source and the power source. The controller is capable of providing sequential illumination signals to the at least two substantially flat areas.

In some embodiments, a receiver is connected to the power source and the controller and configured to receive electromagnetic signals from a remote source.

In some embodiments, the receiver indicates to the controller the presence of a received signal from a remote source; and the controller changes light emitted from the light source in response to the received signal.

Another general aspect of the invention is an illuminated ski having an electroluminescent light source disposed on at least one surface of a ski body, the light source being connected to a positive charge substrate and a negative charge substrate; a direct current power source; and a controller connected between the power source and the light source.

In some embodiments, the ski body contains a channel formed in the edges surrounding the ski body; and the light source is contained within the channel.

In some embodiments, the light source is a substantially flat display area including an electroluminescent material.

In some embodiments, the light source is placed on the top surface of the ski body.

In some embodiments, the light source is placed beneath a substantially clear protective layer on the top surface of the ski body.

In some embodiments, the light source is placed on the bottom surface of the ski body. In some embodiments, the light source is placed beneath a substantially clear protective layer on the bottom surface of the ski body.

In some embodiments, the light source is secured to a surface of the ski body with adhesive.

### BRIEF DESCRIPTION OF THE DRAWINGS

Many additional features and advantages of the present invention will be realized by those skilled in the art upon reading the following detailed description, when considered in conjunction with the drawings, in which:

FIG. 1 is a plan view of a ski incorporating a battery and a lighting source incorporated into the edges of a ski.

FIG. 2 is a cutaway view of the ski in FIG. 1.

FIG. 3 is a plan view of a ski incorporating an alphanumeric display and sequentially illuminated graphics that simulate motion.

### DETAILED DESCRIPTION OF THE INVENTION

The present invention is an illuminated ski body having an onboard power source and a light source operatively connected to the power source. The light source can be either placed in a channel formed in the periphery of the ski body, or embody a substantially flat, illuminated area on or near the top or bottom surface of the ski body.

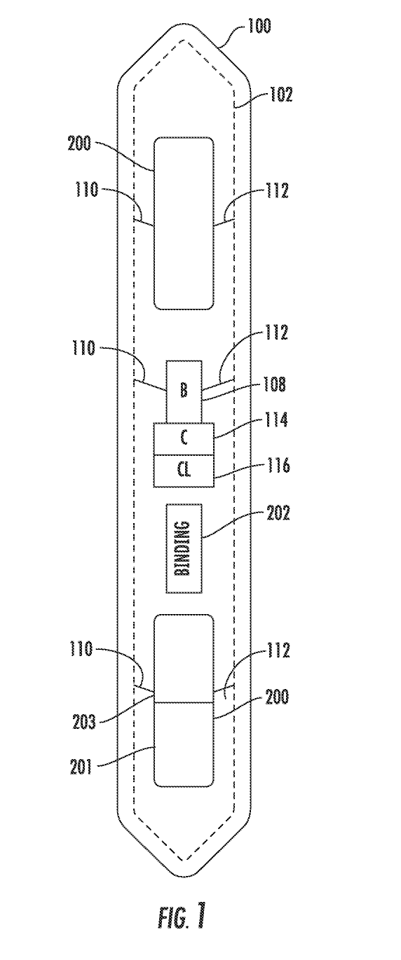

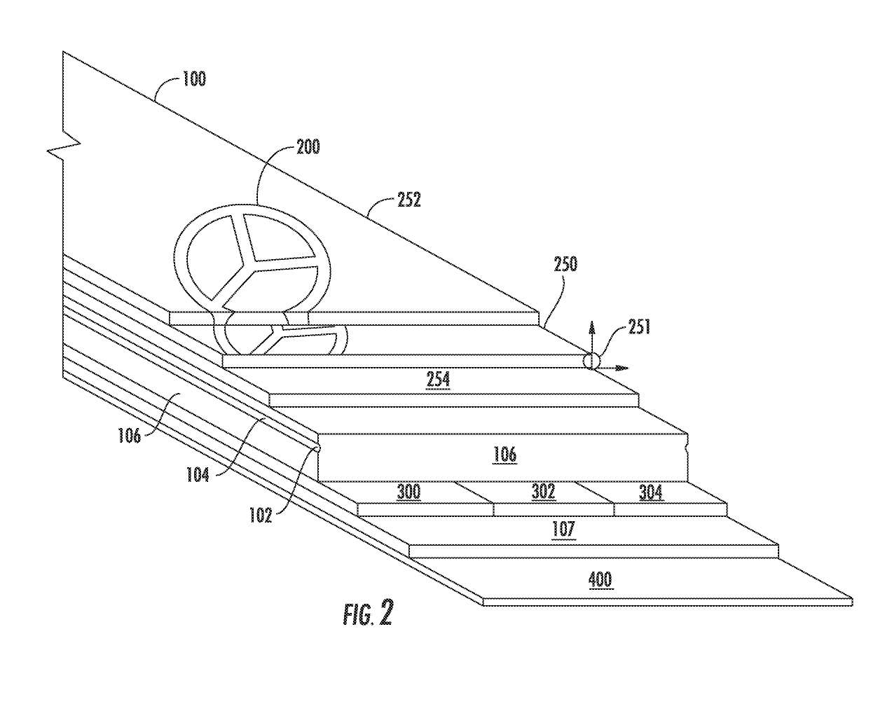

Directing attention to FIGS. 1 and 2, ski body 100 utilizes light source 102 placed in channel 104 (FIG. 2) formed in the periphery of ski body 100. In some embodiments, channel 104 is formed in the core or central layer 106 of ski body 100. In an embodiment, extended light source 102 is embodied in an elongated form such as found in electroluminescent wire. In an embodiment, a power source is provided by removable battery pack 108 attached to the top surface of ski body 100. In some embodiments, battery pack 108 is embedded in ski body 100. Battery pack 108 utilizes carbon-based batteries in some embodiments, and lithium ion batteries in other embodiments. In some embodiments, a photovoltaic panel and a charge port such as a USB port are provided to charge battery pack 108. Battery pack 108 is connected to positive lead 110 and negative lead 112, which are also attached to light source 102, to deliver electrical current to electroluminescent materials used on ski body 100 and thereby provide illumination.

Light source 102 can be selected based on color. In some embodiments, light source 102 can change color during operation, flash on and off, or vary illumination intensity to provide a pulsing effect. Light source 102 and graphics 200 can be illuminated in sequence to simulate motion, for example a “chase” effect where light source 102 is divided into a plurality of segments, and illumination shifts from one segment to another along light source 102, or graphics 200 being divided into a first illuminated portion 201 and a second illuminated portion 203, which are illuminated in alternation or in a sequence to simulate motion.

In some embodiments, graphics 200 includes an alphanumeric display. In an embodiment, controller 114 can be included on ski body 100 in a similar manner as battery pack 108 to operate light source 102 to achieve these and other desired visual effects. Controller 114 also can allow a skier to signal other skiers for help, similar to the manner in which skis are placed in a crossed manner signifies that a skier needs help. Controller 114 can also include communication link 116 to receive remote control signals, so that lighting can be controlled by an external source. Such remote control can be used to signal a user to take a desired action. For example, flashing light source 102 can tell the user to come to a specific location, or beware of an obstacle that may present a threat to a downhill skier on a particular run.

A smart phone also can be used to communicate with controller 114 over communication link 116.

Battery pack 108 also can power illuminated graphics 200 placed on a horizontal face of ski body 100. As shown, graphics 200 are made from substantially flat, electrically conductive material such as electroluminescent paint, or vinyl, such as decals or the like, and connected to positive lead 110 and negative lead 112, such that current from battery pack 108 flows through graphics 200, thereby illuminating an image placed on the top or bottom surface of ski body 100. Positive and negative leads 110 and 112 can be run through channel 104 to graphics 200, or between layers of the laminate ski body 100. Graphics 200 may be placed anywhere on the horizontal surface of ski body 100, top or bottom. As shown in FIG. 1, graphics 200 are placed on the forward and rear portions of the top surface of ski body 100, but may also be placed in the central area near bindings 202. As with light source 102, controller 114 can be connected to graphics 200 to implement effects such as color changes, flashing, and intensity changes.

Directing attention to FIG. 2, in some embodiments, graphics 200 is placed on the surface of under layer 250. As shown in FIG. 1, graphics 200 is attached to leads 110 and 112. Then, top layer 252, substantially transparent as described above, is applied to graphics 200 or light source 251 (an elongated electroluminescent material similar to light source 102) and under layer 250. Light source 251, located beneath a clear coat top layer 252 and at the periphery of ski body 100, emits light in vertical and horizontal directions. While in these embodiments, graphics 200 is relatively permanent due to top layer 252, but in other embodiments graphics 200 is removeably applied using peel-off adhesive to the topmost surface of ski body 100 for ease of reconfiguration when different graphics are desired.

In embodiments where graphics 200 appears on the top surface, graphics 200 are placed on top of leads 110 and 112 (also made accessible to the top surface of ski body 100) using adhesive so that, when replacement of graphics 200 is desired, graphics 200 is simply peeled off and a new graphics 200 may be installed and connected to leads 110 and 112. Similarly, additional graphics can be added, as long as current is supplied either directly through the conductive layer of graphics 200 or from leads 110 and 112.

While FIG. 2 illustrates construction techniques. It is to be understood that in various embodiments, the present invention is retrofitted to existing skis. For example, rather than placing electroluminescent material of graphics 200 beneath layers of clear resin, the electroluminescent material can be applied to the topmost surface of any existing ski body. Similarly, channel 104 can be formed in any existing ski body and light source 102 placed therein.

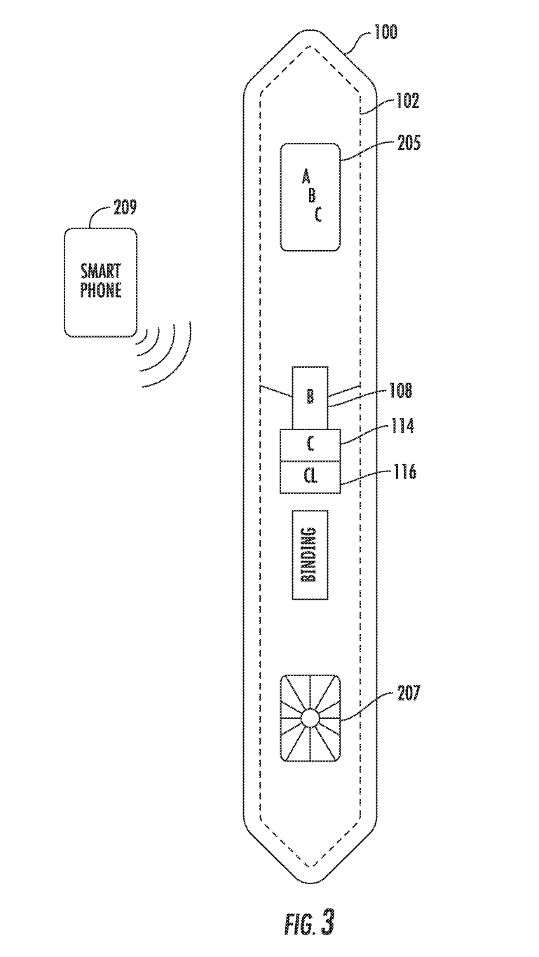

Directing attention to FIG. 3, there is shown an alphanumeric display 205 and simulated motion graphics 207. Alphanumeric display 205 can be an illuminated, readable message implemented through electroluminescent material described above, or, in another embodiment, a flat panel display connected to controller 114. Smart phone 209, possibly carried by the person using ski body 100, can communicate with controller 114 via communication link 116 to display desired messages on alphanumeric display 205. Simulated motion graphics 207 can be illuminated one area at a time in a sequential manner, or illumination can be interleaved with half of the areas flashing followed by the other half of the areas flashing. Many other configurations can be utilized in this manner for graphics 207 to show a dynamic display.

It is to be understood that while the above discussion focuses on the top surfaces of ski body 100, the same techniques in constructing ski body 100 can be used to illuminate the bottom surface 400 and lower layers of ski body 100 in some embodiments.

Referring again to FIG. 2, positive and negative charge can also be delivered to various areas on ski body 100 by providing positive charge substrate 300, an insulating ferroelectric substrate 302, and negative charge substrate 304. If the bottom surface of layer 106 and the top surface of layer 107 are both coated with a ferroelectric material, positive and negative charges can be delivered the entire length of ski body 100 and divided between right and left sides of ski body 100. In this manner, connection to substrates 300 and 304 can be provided through vertical connections placed through intervening layers above or below substrates 300 and 304.

Multiple layers within ski body 100 can include electroluminescent materials to provide varying effects. For example, by changing colors or images displayed on layers 250 and 254, for example, complex visual effects such as motion can be achieved.

While a conventional snow ski is illustrated in FIGS. 1-3, it is to be understood that embodiments of the present invention can be used on snowboards, noboards, fat skis, waterskis, and the like. Numerous modifications can be made to the various embodiments of the present invention without departing from the spirit thereof.

What is claimed is:

1. An illuminated snow ski, comprising:
a snow ski body having disposed thereon a power source;
first and second conductive leads connected to the power source; and
a spatially extended electroluminescent light source connected to the first and second conductive leads.

2. The illuminated snow ski of claim 1, wherein:
the spatially extended electroluminescent light source includes at least one electroluminescent wire extending along an edge of the ski body.

3. The illuminated snow ski of claim 2, wherein:
the ski body includes a channel formed within the edges of the ski body; and
the spatially extended light source is disposed within the channel.

4. The illuminated ski of claim 1, wherein:
the power source is embedded within the top surface of the ski body.

5. The illuminated ski of claim 4, wherein:
the power source is embedded in a central area of the top surface of the ski body.

6. The illuminated ski of claim 1, wherein:
the spatially extended light source includes a substantially flat electroluminescent material that is placed on at least one of the top surface and the bottom surface of the ski body.

7. The illuminated ski of claim 1, wherein:
the spatially extended light source includes a substantially flat electroluminescent material that is shaped so as to form a pattern of illumination on at least one of the top surface and the bottom surface of the ski body.

8. The illuminated ski of dam 1, wherein:
the spatially extended light source includes at least two substantially flat areas of electroluminescent material that are each shaped so as to form at least two respective patterns of illumination on at least one of the top surface and the bottom surface of the ski body.

9. The illuminated ski of dam 8, wherein:
the at least two substantially flat areas of electroluminescent material are sequentially illuminated so as to create a motion effect.

10. The illuminated ski of claim 9, further comprising:
a controller, the controller connected between the light source and the power source, the controller being capable of providing sequential illumination signals to the at least two substantially flat areas.

11. The illuminated ski of claim 10, further comprising:
a receiver, the receiver connected to the power source and the controller and configured to receive electromagnetic signals from a remote source.

12. The illuminated ski of claim 11, wherein:
the receiver indicates to the controller the presence of a received signal from a remote source; and
the controller changes light emitted from the light source in response to the received signal.

13. An illuminated ski, comprising:
a electroluminescent light source disposed on at least one surface of a ski body, the light source being connected to a positive charge substrate and a negative charge substrate;
a direct current power source; and
a controller connected between the power source and the light source.

14. The illuminated ski of claim 13, wherein:
the ski body contains a channel formed in the edges surrounding the ski body; and
the light source is contained within the channel.

15. The illuminated ski of claim 13, wherein:
the light source is a substantially flat display area including an electroluminescent material.

16. The illuminated ski of claim 15, wherein:
the light source is placed on the top surface of the ski body.

17. The illuminated ski of claim 15, wherein:
the light source is placed beneath a substantially dear protective layer on the top surface of the ski body.

18. The illuminated ski of claim 15, wherein:
the light source is placed on the bottom surface of the ski body.

19. The illuminated ski of claim 15, wherein:
the light source is placed beneath a substantially clear protective layer on the bottom surface of the ski body.

20. The illuminated ski of claim 15, wherein:
the light source is secured to a surface of the ski body with adhesive.
